(19) United States
(12) Patent Application Publication
(10) Pub. No.: US 2012/0070110 A1
(43) Pub. Date: Mar. 22, 2012

(54) GEARBOX ASSEMBLY COMPONENT AND METHOD

(76) Inventor: Steven J. Owens, Waterford, PA (US)

(21) Appl. No.: 12/886,650

(22) Filed: Sep. 21, 2010

(51) Int. Cl. F16C 23/06; B23P 15/00; B23P 11/00

(52) U.S. Cl. 384/563; 29/893; 29/896.9

(57) ABSTRACT

A ring spring for use in a roller bearing assembly includes one or more inner rings and an outer ring operatively connected to the inner rings. Axial compression of the inner rings displaces the outer ring radially to secure bearings in the roller bearing assembly.

### FIELD OF THE INVENTION

Embodiments of the invention relate generally to gearbox assembly components and methods, and more particularly to components and methods for accommodating bearings within a gearbox.

### BACKGROUND OF THE INVENTION

It is often desirable to secure a rotatable shaft to a gearbox. This is particularly true with wind turbines that include turbine blades mounted on a rotor head and a rotatable shaft coupled to the head. In particular, the shaft rotates with the rotor head and is typically mounted in bearings that are seated within a gearbox housing. The bearings absorb radial and axial forces between the rotating shaft and the housing. While various types of bearings are used to absorb such forces, tapered roller bearings are often used in wind turbine gearboxes.

Tapered roller bearings are typically set within the turbine gearbox housing in either a “pre-load” or “end play” setting during the gearbox assembly process. Securing the bearings in either of these settings requires the use of custom spacers or shims that are sized in accordance with gearbox component tolerances. As will be appreciated, the creation of custom components requires a separate manufacturing step having associated costs and challenges.

In view of the above, a need exists for a gearbox that may be manufactured and assembled at a reduced cost with a greater ease of manufacture than is presently possible.

### BRIEF DESCRIPTION OF THE INVENTION

In one embodiment of the invention, a ring spring for use in a roller bearing assembly includes a plurality of inner rings, and an outer ring operatively connected to the plurality of inner rings. Compression of the inner rings displaces the outer ring radially to secure bearings in the roller bearing assembly.

In another embodiment of the invention, a gearbox has a roller bearing stack and a ring spring assembly in biased contact with the roller bearing stack to secure the stack in either a pre-load or end play setting.

In another embodiment of the present invention, an assembly for adjusting rotational speed and torque includes a first sub-assembly for minimizing friction between two interconnected components within the assembly and capable of accommodating a relatively heavy radial load, and also includes a second sub-assembly for securing the first sub-assembly in a pre-load or end play setting within the assembly.

In another embodiment of the present invention, a method of assembling a gearbox includes placing at least one roller bearing within a gear train of the gearbox and securing a biasing mechanism to the gearbox to hold the at least one roller bearing in a pre-load or end play setting within the gear train.

In another embodiment of the present invention, a method of operating a gearbox includes biasing at least one roller bearing within a gear train of the gear box, and adjusting rotational speed and torque of an input shaft through the use of the gear train.

In another embodiment of the present invention, a method for manufacturing a ring spring assembly that includes two inner rings operatively connected to an outer ring at mating surfaces on the inner and outer rings, the mating surfaces having supplementary inclination angles, includes selecting a desired stiffness for the ring spring assembly. The method further includes forming the mating surfaces with supplementary inclination angles sufficient to obtain the desired stiffness.

### BRIEF DESCRIPTION OF THE DRAWINGS

The present invention will be better understood from reading the following description of non-limiting embodiments, with reference to the attached drawings, wherein below:

FIG. 1 shows a side sectional view of a wind turbine gearbox assembly.

FIG. 2 shows a schematic view of a tapered roller bearing for use in the gearbox shown in FIG. 1.

FIG. 3 shows a partial side sectional view of the gearbox shown in FIG. 1, including a ring spring pre-load component according to an embodiment of the present invention.

FIG. 4 shows a detailed radial section view of the ring spring shown in FIG. 3.

FIG. 5 shows a flow chart illustrating method steps for constructing a wind turbine gearbox, according to an embodiment of the present invention.

### DETAILED DESCRIPTION OF THE INVENTION

Reference will be made below in detail to exemplary embodiments of the invention, examples of which are illustrated in the accompanying drawings. Wherever possible, the same reference numerals used throughout the drawings refer to the same or like parts.

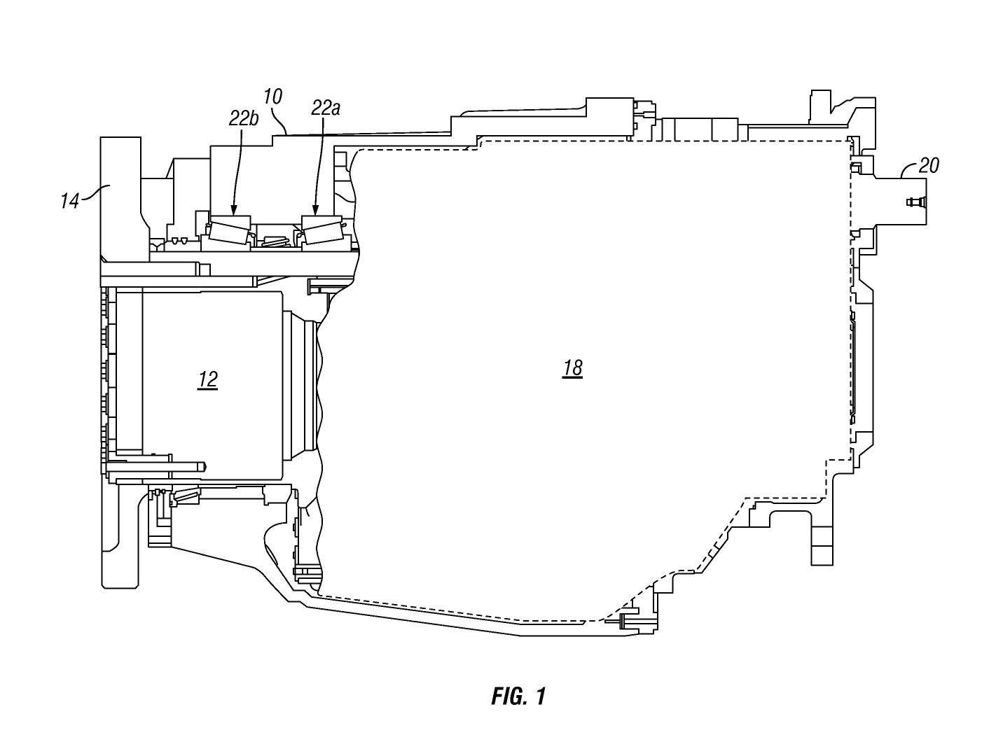

Referring to FIG. 1, a wind turbine gearbox 10 houses a main shaft 12 with an input flange 14 for mounting a rotor blade or sail assembly (not shown) that rotates the main shaft according to wind speed, and also houses an output shaft 20 that typically drives a rotor of an electrical generator (not shown). The main shaft 12 drives the output shaft 20 via a gear train, generally represented by reference number 18, which imparts axial thrust along the main shaft 12. The gear train 18 may, for example, be either helical or hypoid, although, as will be appreciated, other configurations may be employed without departing from the scope of the invention. Regardless of the specific gear train configuration used, tapered roller bearings 22 are provided as inward and outward carrier bearings 22a, 22b in a “stack” for restraining axial motion of the main shaft due to wind loading and due to bull gear thrust, (the tapered roller bearings are also referred to herein as the “first sub-assembly”).

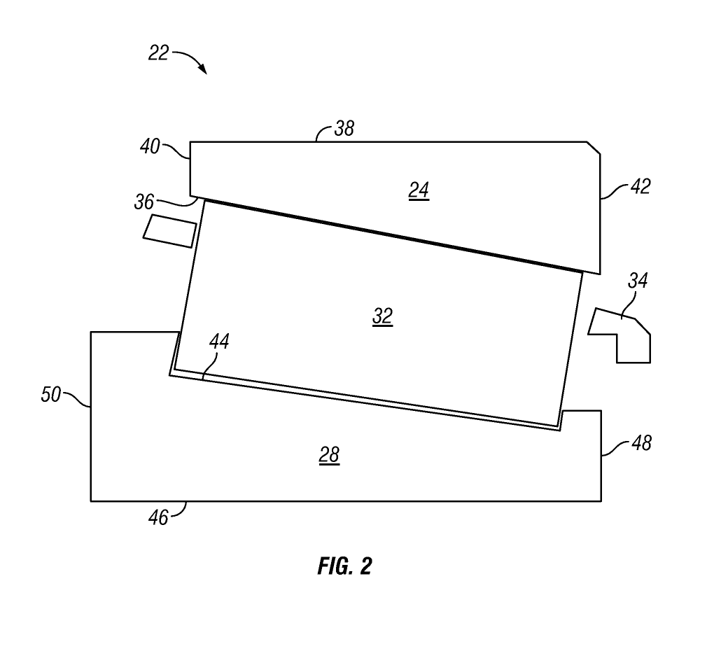

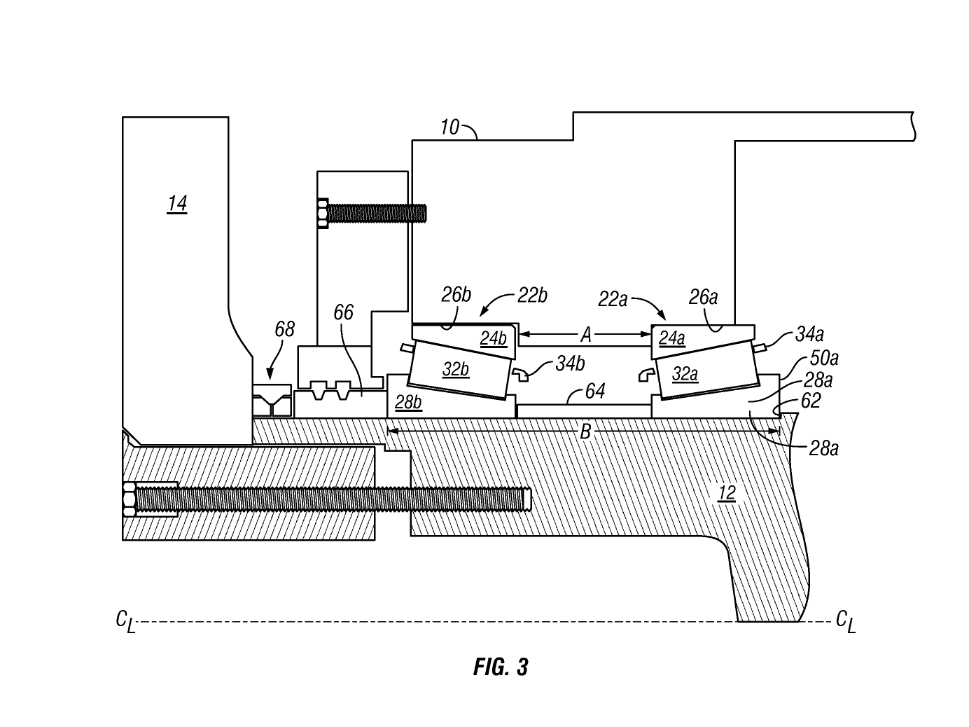

As shown in FIGS. 2 and 3, each tapered roller bearing 22a, 22b includes an outer race 24 that is mounted into a housing 26a or 26b formed in the gearbox 10, an inner race 28 that is mounted onto the main shaft 12, a plurality of conical tapered rollers 32 captured between the outer race 24 and the inner race 28, and a cage 34 supporting and aligning the plurality of tapered rollers. The outer race 24 includes a conical inner circumferential surface 36 that contacts the tapered rollers 32, a cylindrical outer circumferential surface 38 that fits into the housing 26, a radial annular toe 40, and a radial annular heel 42. As will be appreciated, the structures shown in FIGS. 2 and 3 are substantially symmetric about a centerline CL, as best shown in FIG. 3.

The inner race 28 of each bearing 22 similarly includes a conical outer circumferential surface 44 that contacts the tapered rollers 32, a cylindrical inner circumferential surface 46 that is slipped onto the shaft 12, a radial annular toe 48, and a radial annular heel 50. The outer and inner races 24, 28 are arranged heel-to-toe with the tapered rollers 32 captured between the conical facing circumferential surfaces 36, 44 of the two races. The axes of the tapered rollers, as well as the conical surfaces of the outer race, of the inner race, and of the tapered rollers, all converge to a common point providing for slip-free rotation of the rollers between the inner and outer races.

For optimal performance the rollers or bearings 32 of the tapered roller bearing pair 22a, 22b may be axially compressed or pre-loaded. Pre-load enhances rolling contact between the conical surfaces while minimizing slippage motion that can cause galling and gouging of rollers and/or races. To provide for pre-load, the bearing pair 22a, 22b are mounted in axial opposition, so that axial motion of the shaft that would separate the races of one bearing 22a would force together the races of the other bearing 22b.

More specifically, as shown in FIG. 3, the heel 50a of the inner race 28a of the inward carrier bearing 22a is seated against a bearing shoulder 62 formed on the main shaft 12. The inner race 28b of the outward carrier bearing 22b is provided with a limited axial float along the main shaft 12 for pre-load purposes. The inner race 28b of the outward carrier bearing 22b is pre-loaded toward the inner race 28a of the inward carrier bearing 22a in order to maintain slip-free rotation of the tapered rollers 32 between the outer and inner races 24 and 28 of each bearing 22a, 22b. The substantially matching pre-load forces exerted on the tapered roller bearings 22a, 22b can be determined based on the specified dimensions of the rollers 32 and of the bearing races 24, 28 along with a outer axial assembly dimension A of the gearbox housing 10 between the bearing housings 26a, 26b and an inner axial assembly dimension B of the bearings 22a, 22b between the heels 50a, 50b of the inner races 28a, 28b.

In one embodiment of the invention, the inner race 28b of the outward carrier bearing 22b is biased in a pre-load state against the bearing spacer bushing 64 via a seal spacer bushing 66 by a “ring spring” compressive pre-load component 68 (also referred to herein as a “ring spring assembly” and as the “second sub-assembly”) which is disposed between the seal spacer bushing 66 and the input flange 14. The bearing spacer bushing 64 limits the pre-load applied to the rollers 32 of the outward carrier bearing 22b, by setting a lower limit on the inner axial assembly dimension 63. The input flange 14 and the main shaft 12 transmit pre-load from the compressive component 68 via the bearing shoulder 62 to the inner race 28a of the inward carrier bearing 22a.

In another embodiment of the invention, by manufacturing the bearing spacer bushing 64 to a sufficiently large axial length, pre-load on the bearings 22a, 22b can be eliminated while the inner races 28a, 28b are kept securely positioned against the bearing shoulder 62 by the ring spring 68. In this embodiment, the bearings 22a and 22b are in an end play setting, and are fixed in this setting by the ring spring 68.

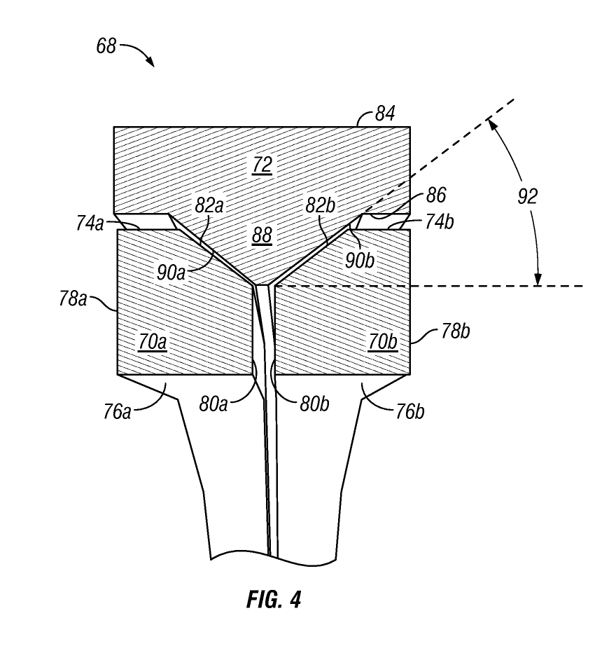

Referring now to FIG. 4, in an embodiment of the invention, the ring spring 68 includes first and second inner rings 70a, 70b and an outer ring 72. Each inner ring 70a, 70b has an outer cylindrical surface 74a, 74b, an inner cylindrical surface 76a, 76b, a radial outward end face 78a, 78b, a radial inward end face 80a, 80b, and a chamfered annular spring face 82a, 82b extending from the radial inward end face to the outer cylindrical surface. The outer ring 72 includes an outer cylindrical surface 84 and an inner cylindrical surface 86, with an inward annular protrusion 88 extending from the inner cylindrical surface. The inward annular protrusion 88 of the outer ring 72 includes first and second angled contact faces 90a, 90b.

When the ring spring 68 is assembled, the spring faces 82a, 82b of the inner rings 70a, 70b are in sliding contact (i.e., slidably engaged) with the adjacent contact faces 90a, 90b of the outer ring 72. Accordingly, axial compression of the inner rings 70a, 70b toward each other causes radial expansion of the outer ring 72 due to wedging action of the spring faces 82a, 82b and the contact faces 90a, 90b. Thus, the tensile hoop strain induced in the outer ring 72 by inward axial motion of the inner rings 70a, 70b causes the ring spring 68 to act as an axial compression spring. That is, the sliding contact faces 82a, 82b and 90a, 90b define a path of mutual travel between the outer ring 72 and the inner rings 70a, 70b. Accordingly, as the inner rings are forced together along the path of travel, the outer ring is forced radially outward, inducing a restoring hoop stress in the outer ring. The hoop stress of the outer ring exerts a restoring force normal to the defined path of travel, pushing apart the inner rings. Thus, the hoop stress in the outer ring 72 provides almost all of the axial spring force. It is anticipated that friction along the path of travel may also provide a damping force, which may in some circumstances act equivalent to a spring force. The mating surfaces of the spring faces 82a, 82b and the contact faces 90a, 90b are configured with supplementary conical wedging angles or inclination angles 92, which can be selected to adjust the compressive stiffness of the ring spring 68.

For example, wedging angles 92 of between thirty (30) and sixty (60) degrees provide a usable range of stiffness, while a wedging angle of between forty (40) and fifty (50) degrees is desirable and a wedging angle of about forty-five (45) degrees is believed to be optimal to provide similar bilinear stiffness characteristics. (In another aspect, it is believed that a wedging angle of within a tolerance of 45 degrees would be optimal as indicated; “within a tolerance” meaning 45 degrees plus or minus one degree, to account for manufacturing tolerances). Spring response also can be adjusted by controlling the coefficient of friction between the spring faces. For example, a greater coefficient of friction produces greater compressive stiffness for a wedging angle of about forty-five (45) degrees. For any wedging angle, as friction between the contacting parts increases, the stiffness curves diverge depending on the direction of displacement. Providing a narrower wedging angle 92 with a relatively high coefficient of friction also can produce an axial tensile restraining force, which can rapidly drop off as the inner rings are pulled apart.

In an embodiment of the invention, the ring spring 68 is configured such that the outward faces 78a, 78b of the inner rings 70a, 70b are spaced apart at a first distance in an unloaded but assembled state, and such that the ring spring provides a compressive spring force of about 180,000 N (or within a tolerance of 180,000 N, meaning 180,000 N plus or minus 1%) when the inner rings 70a, 70b are moved together to a second distance less than the first distance, but not touching, in a compressed state. The seal spacer bushing 66 and the bearing spacer bushing 64 can be match-machined to provide desirable pre-load of the carrier bearing rollers 32 by controlling the heel-to-heel distance 63 of the inner races 28a, 28b. Advantageously, the ring spring 68 provides pre-load force throughout a range of inner ring compression such that the match-machining tolerance for the seal spacer bushing 66 and the bearing spacer bushing 64 can be broader than previously accepted.

Additionally, the compressive force of the ring spring 68 can cause the radial outward end faces 72a, 72b to frictionally contact the input flange 14 and the seal spacer bushing 66, thus transmitting shear forces from the input flange via the ring spring and the seal spacer bushing to the inner race 28b of the outward roller bearing 22b, so that the shear plane of the overall assembly is maintained between the input flange 14 and the main shaft 12.

For withstanding hoop stresses, as well as axial compressive stresses, the inner and outer rings 70a, 70b, 72 of the ring spring 68 can be fabricated from a material with high tensile and compressive ultimate strengths, yield strength, and yield strain. For example, 6150 spring steel or other hardened spring steel (e.g., quenched and tempered to a hardness of about 34 Rc, or within a tolerance of 34 Rc, meaning 34 Rc plus or minus 1%) has been found suitable for making the ring spring 68. Alternatively, an alloy steel such as 4340 steel also can be acceptable with suitable heat treatment. Shot peening or similar surface treatments can be used to enhance hardness, surface finish, and fatigue life of the inner and outer rings.

A ceramic-zinc-aluminum water-based coating can be applied to each component of the ring spring to control friction between the spring faces 82a, 82b and the contact faces 90a, 90b, and to protect the entire ring spring 68 from corrosion and abrasion. Specifications for such commercially available integrally lubricated coatings list friction coefficients between 0.12 and 0.18. To gain further reduction in friction, an anti-seize type lubricant such molybdenum disulfide grease or a metal-graphite-grease composition may be applied to the conical spring faces. In some embodiments, lubricants are applied to achieve a coefficient of friction in the range of about 0.04 to 0.05. This will significantly reduce the clamping load required to compress the spring.

Thus, low friction due to lubrication at assembly can permit the ring spring 68 to provide sufficient pre-load for run-in of the roller bearings 22a, 22b. Greater friction due to lubricant breakdown and wear of the mating surfaces 82a, 82b, 90a, 90b is expected to increase the stiffness of the ring spring 68, making it less likely to displace, such that after an extended period of operation the ring spring can essentially function as a fixed spacer.

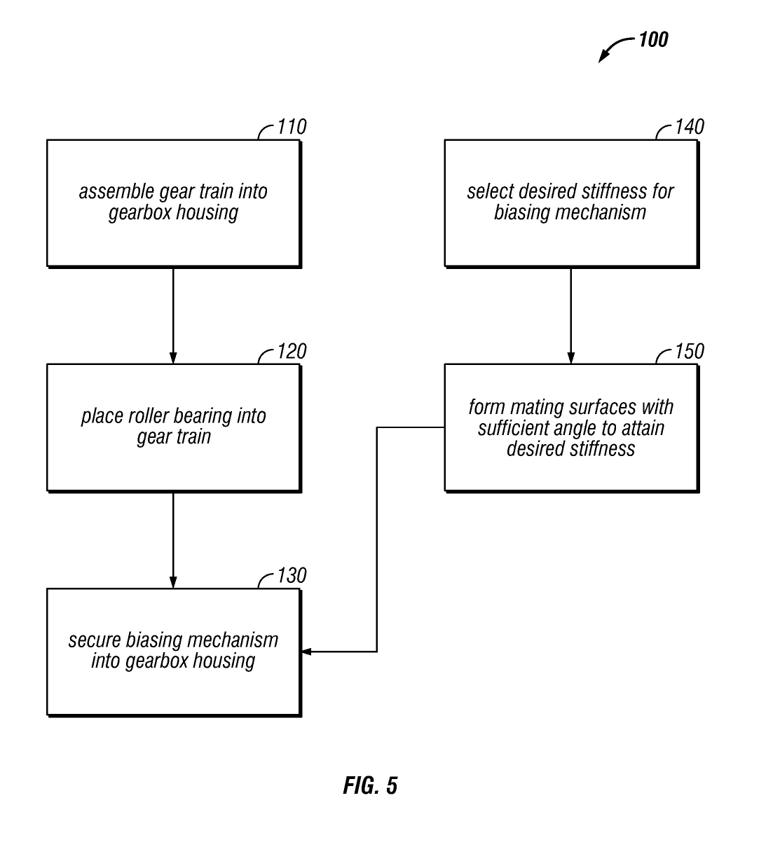

FIG. 5 illustrates a method 100 for manufacturing a wind turbine gearbox, according to an embodiment of the invention. The method 100 includes a step 110 of assembling a gear train into a gearbox housing. The method further includes a step 120 of placing at least one roller bearing into the gear train for supporting the gear train against axial and/or radial forces. The method further includes a step 130 of securing a biasing mechanism to the gearbox housing to hold the at least one roller bearing in a pre-loaded state within the gear train. In embodiments of the inventive method, the biasing mechanism is a ring spring that includes two inner rings that are operatively connected to an outer ring at mating surfaces on said inner and outer rings, the mating surfaces having supplementary inclination angles.

The ring spring biasing mechanism can be manufactured according to a method including the step 140 of selecting a desired stiffness for the biasing mechanism and the step 150 of forming the mating surfaces with supplementary inclination angles sufficient to attain the desired stiffness. For example, the mating surfaces inclination angles and coefficients of friction may be selected as described above with reference to FIG. 4.

An embodiment of the inventive apparatus may include a compressive component with an outer ring and two inner rings operatively connected to the outer ring via angled mating surfaces, wherein axial compression of the inner rings toward each other causes outward radial displacement of the outer ring. Hoop stresses in the outer ring thereby provide a restoring force that causes the component to behave as an axial compression spring with a linear stiffness characteristic. In some embodiments of the invention, one of the inner rings may be omitted, or additional inner rings or outer rings may be included. Angles and coefficients of friction may be varied according to desired restoring force or stiffness.

In another embodiment, a ring spring assembly includes first and second inner rings and an outer ring. The first inner ring comprises an annular ring body. The body has an outer cylindrical surface, and a radial outward end face that meets the outer cylindrical surface at about a right angle (meaning a 90 degree angle plus or minus manufacturing tolerances). The first inner ring body also has an inner cylindrical surface, which meets the outer cylindrical surface at about a right angle. The inner and outer cylindrical surfaces are about parallel. The first inner ring body also has a radial inward end face, which meetings the inner cylindrical surface at about a right angle. The radial inward end face is about parallel to the radial outward end face. The body also has a chamfered annular spring face. The spring face extends between an outward terminus edge of the radial inward end face and an inward terminus edge of the outer cylindrical surface. Thus, where the outer cylindrical surfaces faces radially outwards, and the radial inward end face faces along an central axis of the inner ring, the spring face is inclined between the radially outwards and axial directions (e.g., at a 45 degree angle). The second inner ring is substantially identical to the first inner ring (meaning the same but for manufacturing tolerances), but faces the opposite direction, e.g., if the spring face of the first inner ring is inclined towards a first direction of the axis, the spring face of the second inner ring is inclined towards the second, other direction of the axis, such that the two spring faces generally face one another. The outer ring includes an outer cylindrical surface, and an inner cylindrical surface that is about parallel to the outer cylindrical surface (both surfaces are about parallel to the cylindrical surfaces of the inner rings). The outer ring further includes an inward annular protrusion extending radially inwards from the inner cylindrical surface. The inward annular protrusion of the outer ring is generally triangular or trapezoidal in cross section, and includes first and second angled contact faces. With respect to a radial axis of the outer ring, which is perpendicular to the outer and inner cylindrical surfaces of the outer ring, each of the first and second angled contact faces is oriented at the same angle, e.g., the outer ring is bilaterally symmetric with respect to the radial axis. The first contact face of the outer ring annular protrusion is oriented towards, and is about parallel to, the spring face of one of the inner rings, and the second contact face of the outer ring annular protrusion is oriented towards, and is about parallel to, the spring face of the other one of the inner rings. When the inner rings are urged axially towards one another, the annular protrusion of the outer ring slides along the spring faces of the inner rings and the outer ring is urged radially outwards.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting and are exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” “third,” “upper,” “lower,” “bottom,” “top,” etc. are used merely as labels, and are not intended to impose numerical or positional requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose several embodiments of the invention, including the best mode, and also to enable any person skilled in the art to practice the embodiments of invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

As used herein, an element or step recited in the singular and preceded by the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

Since certain changes may be made in the above-described gearbox assembly component and method, without departing from the spirit and scope of the invention herein involved, it is intended that all of the subject matter of the above description or shown in the accompanying drawings shall be interpreted merely as examples illustrating the inventive concept herein and shall not be construed as limiting the invention.

What is claimed is:

1. A ring spring for use in a roller bearing assembly, said ring spring comprising:
a plurality of inner rings;
an outer ring operatively connected to said plurality of inner rings; and
wherein compression of said inner rings displaces said outer ring radially to secure bearings in said roller bearing assembly.

2. The ring spring of claim 1 wherein said plurality of inner rings are two inner rings.

3. The ring spring of claim 2, wherein each of said two inner rings has a chamfered annular surface.

4. The ring spring of claim 3, wherein said outer ring has an annular protrusion on an inner surface of said outer ring, said protrusion including two opposed contact surfaces.

5. The ring spring of claim 4, wherein said chamfered annular surfaces of said two inner rings slidably engage said opposed contact surfaces of said outer ring, and said opposed contact surfaces define a path of travel of said outer ring relative to said two inner rings.

6. A gearbox comprising:
a roller bearing stack; and
a ring spring assembly, said ring spring assembly being in biased contact with said roller bearing stack to secure said roller bearing stack in either a pre-load or end play setting.

7. The gearbox of claim 6, wherein said ring spring assembly comprises a plurality of annular rings.

8. The gearbox of claim 7, wherein said plurality of annular rings comprises three annular rings.

9. The gearbox of claim 8, wherein said three annular rings comprise:
an outer ring; and
two inner rings operatively connected to said outer ring.

10. The gearbox of claim 9, wherein each of said two inner rings has a chamfered annular surface and said outer ring has an annular protrusion on an inner surface of said outer ring, said annular protrusion including two opposed contact surfaces that slidably engage said chamfered annular surfaces of said two inner rings.

11. The gearbox of claim 10, wherein said chamfered annular surfaces are chamfered at an angle of about 45 degrees.

12. The gearbox of claim 7, wherein said plurality of annular rings have a hardness of about 34 Rc.

13. The gearbox of claim 7, wherein said plurality of annular rings are manufactured from hardened spring steel.

14. The gearbox of claim 7, wherein said plurality of annular rings have a coefficient of friction of about 0.04 to about 0.05.

15. The gearbox of claim 6, wherein said gearbox is a wind turbine gearbox.

16. The gearbox of claim 6, wherein said ring spring assembly provides at least about 180,000 N of force on said roller bearing stack.

17. An assembly for adjusting rotational speed and torque, said assembly comprising:
a first sub-assembly for reducing friction between two interconnected components within said assembly, said first sub-assembly being capable of accommodating a radial load; and
a second sub-assembly for securing said first sub-assembly in either a pre-load or end play setting within said assembly.

18. The assembly of claim 17, wherein said first sub-assembly is at least one taper roller bearing.

19. The assembly of claim 17, wherein said second sub-assembly is a ring spring.

20. The assembly of claim 19, wherein said ring spring comprises a plurality of annular rings.

21. The assembly of claim 20, wherein said plurality of annular rings comprises three annular rings.

22. The assembly of claim 21, wherein said three annular rings comprise:
an outer ring; and
two inner rings operatively connected to said outer ring.

23. The assembly of claim 22, wherein each of said two inner rings has a chamfered annular surface and said outer ring has an annular protrusion on an inner surface of said outer ring, said protrusion including two opposed contact surfaces that slidably engage said chamfered annular surfaces of said inner rings.

24. The assembly of claim 23, wherein said chamfered annular surfaces are chamfered at an angle of about 45 degrees and each of said contact surfaces is at an angle supplementary to said angle of said chamfered annular surfaces.

25. A method of assembling a gearbox, said method comprising the steps of:
placing at least one roller bearing within a gear train of said gearbox; and
inserting a biasing mechanism to said gearbox to secure the at least one roller bearing within the gear train.

26. The method of claim 25, wherein said biasing mechanism is a ring spring.

27. The method of claim 25, wherein said gearbox is configured for use with a wind turbine.

28. A method of operating a gearbox, said method comprising the steps of:
biasing at least one roller bearing within a gear train of said gear box; and
adjusting rotational speed and torque of an input shaft through the use of said gear train.

29. The method of claim 28, wherein said biasing is accomplished through the use of a ring spring.

30. A method of manufacturing a ring spring assembly that includes two inner rings that are operatively connected to an outer ring at mating surfaces on said inner and outer rings, said mating surfaces having supplementary inclination angles, said method comprising the steps of:
selecting a desired stiffness for said ring spring assembly; and
forming said mating surfaces with supplementary inclination angles sufficient to attain said desired stiffness.
